(19) United States
(12) Patent Application Publication
(10) Pub. No.: US 2026/0299631 A1
(43) Pub. Date: Oct. 1, 2026

(54) OPERATION INPUT DEVICE

(71) Applicant: AISIN CORPORATION, Kariya (JP)

(72) Inventor: Hiroshi ISONO, Kariya-shi (JP)

(73) Assignee: AISIN CORPORATION, Kariya (JP)

(21) Appl. No.: 19/567,508

(22) Filed: Mar. 16, 2026

(30) Foreign Application Priority Data
Mar. 31, 2025 (JP) 2025-059459

(51) Int. Cl. G05G 1/46; G05G 1/44

(52) U.S. Cl. CPC G05G 1/46; G05G 1/44

(57) ABSTRACT

An operation input device includes an input member to which a rotational operation force is input, a linearly moving member on a reference axis, a reaction force generating mechanism, and a support member having a support tubular portion. A linear motion conversion mechanism mutually converts rotational motion of the input member and linear motion of the linearly moving member. The linearly moving member is disposed inward in a radial direction of the support tubular portion. The conversion mechanism includes a tubular rotating member disposed outward of the support tubular portion, an inclined cam groove formed in the rotating member, a driven member moving along the cam groove, and a connecting member. An axially extending guide groove penetrates the support tubular portion. The connecting member penetrates the guide groove to connect the driven member and linearly moving member, restricting circumferential rotation.

### CROSS REFERENCE TO RELATED APPLICATIONS

This application is based on and claims priority under 35 U.S.C. § 119 to Japanese Patent Application No. 2025-059459, filed on Mar. 31, 2025, the entire content of which is incorporated herein by reference.

### TECHNICAL FIELD

The present disclosure relates to an operation input device including: an input member to which a rotational operation force is input; a linearly moving member disposed on a reference axis; a linear motion conversion mechanism that mutually converts rotational motion of the input member and linear motion of the linearly moving member along the reference axis; a reaction force generating mechanism that generates a reaction force against the rotational operation force input to the input member and causes the reaction force to act on the linearly moving member; and a support member that supports the input member, the linearly moving member, and the linear motion conversion mechanism.

### BACKGROUND DISCUSSION

An example of such an operation input device is disclosed in the following JP 2008-143334A. Hereinafter, the reference signs in JP 2008-143334A are cited in parentheses in the description of BACKGROUND ART.

In the operation input device of JP 2008-143334 A, the support member (18) includes a support tubular portion (18A) formed in a tubular shape and disposed on a reference axis (12). The linearly moving member (16) is disposed radially inward of the support tubular portion (18A).

The linear motion conversion mechanism includes: a tubular rotating member (14) that is disposed radially outward of the support tubular portion (18A) on the reference axis (12) and rotates in conjunction with rotation of the input member (80); a cam groove (74) formed in the rotating member (14); a driven member (78) that moves along the cam groove (74); and a connecting member (70) that connects the driven member (78) and the linearly moving member (16) in a radial direction.

In the operation input device of JP 2008-143334 A, a through hole for inserting the rod-shaped connecting member (70) is formed to penetrate the linearly moving member (16) in the radial direction. In such a configuration, the rigidity of the linearly moving member (16) is likely to be insufficient, and thus it is necessary to secure large axial and radial dimensions of the linearly moving member (16). As a result, the operation input device is increased in size.

A need thus exists for an operation input device which is not susceptible to the drawback mentioned above.

### SUMMARY

In view of the above, a characteristic configuration of the operation input device includes:
an input member to which a rotational operation force is input;
a linearly moving member disposed on a reference axis;
a linear motion conversion mechanism that mutually converts rotational motion of the input member and linear motion of the linearly moving member along the reference axis;
a reaction force generating mechanism that generates a reaction force against the rotational operation force input to the input member and causes the reaction force to act on the linearly moving member; and
a support member that supports the input member, the linearly moving member, and the linear motion conversion mechanism, in which
defining a direction along the reference axis as an axial direction, a direction orthogonal to the reference axis as a radial direction, and a direction around the reference axis as a circumferential direction,
the support member includes a support tubular portion formed in a tubular shape and disposed on the reference axis,
the linearly moving member is disposed inward in the radial direction of the support tubular portion,
the linear motion conversion mechanism includes:
a tubular rotating member that is disposed outward in the radial direction of the support tubular portion on the reference axis and rotates in conjunction with rotation of the input member;
a cam groove formed in the rotating member so as to extend along a direction inclined with respect to both the axial direction and the circumferential direction;
a driven member that moves along the cam groove; and
a connecting member that connects the driven member and the linearly moving member in the radial direction,
a long hole-shaped guide groove that penetrates the support tubular portion in the radial direction and extends along the axial direction is formed in the support tubular portion, and
the connecting member is fixed to one end portion in the axial direction of the linearly moving member in a state of penetrating the guide groove in the radial direction so that the rotation in the circumferential direction is restricted by an inner surface of the guide groove.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of an operation input device according to a first embodiment;

FIG. 2 is a cross-sectional view of the operation input device according to the first embodiment, taken along the axial direction;

FIG. 3 is a view illustrating a configuration of a linear motion conversion mechanism;

FIG. 4 is a cross-sectional view of an operation input device according to a second embodiment, taken along the axial direction; and

FIG. 5 is a partially enlarged cross-sectional view of the operation input device according to the second embodiment, taken along the axial direction.

### DETAILED DESCRIPTION

### 1. FIRST EMBODIMENT

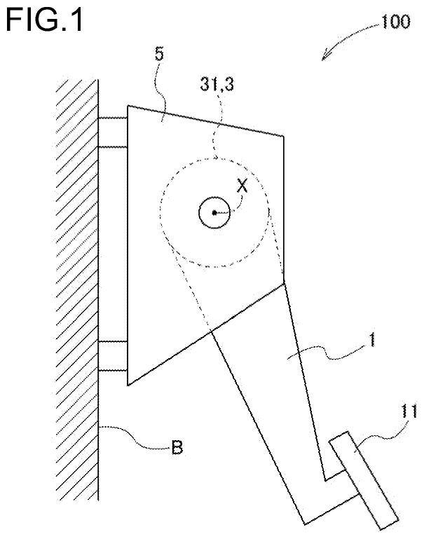

Hereinafter, an operation input device 100 according to a first embodiment will be described with reference to FIGS. 1 to 3. In the present embodiment, the operation input device 100 is fixed to a vehicle body B of a vehicle, as illustrated in FIG. 1.

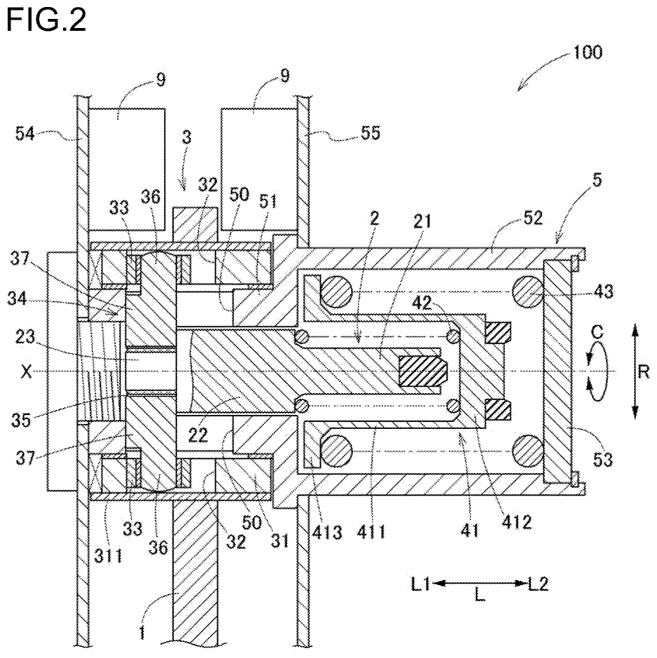

As illustrated in FIG. 2, the operation input device 100 includes an input member 1, a linearly moving member 2, a linear motion conversion mechanism 3, a reaction force generating mechanism 4, and a support member 5.

As illustrated in FIG. 1, the input member 1 is a member to which a rotational operation force is input. In the present embodiment, the input member 1 is an arm member that swings about a reference axis X, and is connected to a pedal 11 operated by a driver of the vehicle, such as an accelerator pedal or a brake pedal. FIG. 1 illustrates a configuration in which the input member 1 and the pedal 11 integrally swing, but another configuration may be adopted in which they may be connected via a gear mechanism, a link mechanism, or the like.

In the following description, a direction along the reference axis X is defined as an “axial direction L”. One side in the axial direction L is defined as a “first axial side L1”, and the other side in the axial direction L is defined as a “second axial side L2”. A direction orthogonal to the reference axis X is defined as a “radial direction R”, and a direction around the reference axis X is defined as a “circumferential direction C”.

The linearly moving member 2 is disposed on the reference axis X. The linearly moving member 2 is configured to be movable in the axial direction L. In the present embodiment, the linearly moving member 2 includes a first shaft portion 21, a second shaft portion 22, and a connecting portion 23.

Each of the first shaft portion 21 and the second shaft portion 22 is formed to extend along the axial direction L. The first shaft portion 21 is disposed on the second axial side L2 with respect to the second shaft portion 22. In the present embodiment, each of the first shaft portion 21 and the second shaft portion 22 is formed in a cylindrical shape centered on the reference axis X. The first shaft portion 21 and the second shaft portion 22 are formed integrally with each other. The first shaft portion 21 is formed to have a smaller diameter than the second shaft portion 22.

The connecting portion 23 is connected to move integrally with the second shaft portion 22. In the present embodiment, the connecting portion 23 is formed to protrude toward the first axial side L1 from the second shaft portion 22. The connecting portion 23 is formed to have a smaller diameter than the second shaft portion 22.

The linear motion conversion mechanism 3 is configured to mutually convert rotational motion of the input member 1 and linear motion of the linearly moving member 2 along the reference axis X.

The reaction force generating mechanism 4 is configured to generate a reaction force against the rotational operation force input to the input member 1 and cause the reaction force to act on the linearly moving member 2. In the present embodiment, the reaction force generating mechanism 4 generates a reaction force that returns the pedal 11 to the initial position when the driver steps on the pedal 11.

The support member 5 is a member that supports the input member 1, the linearly moving member 2, and the linear motion conversion mechanism 3. In the present embodiment, the support member 5 is a housing that accommodates the input member 1, the linearly moving member 2, the linear motion conversion mechanism 3, and the reaction force generating mechanism 4.

The support member 5 includes a support tubular portion 51. The support tubular portion 51 is formed in a tubular shape. The support tubular portion 51 is disposed on the reference axis X. In the present embodiment, the support tubular portion 51 is formed in a cylindrical shape centered on the reference axis X.

A guide groove 50 is formed in the support tubular portion 51. The guide groove 50 is a long hole-shaped groove extending along the axial direction L. The guide groove 50 is formed to penetrate the support tubular portion 51 in the radial direction R. In the present embodiment, a plurality of the guide grooves 50 are disposed to be distributed in the circumferential direction C.

In the present embodiment, the support member 5 further includes a peripheral wall portion 52, a bottom wall portion 53, a first side wall portion 54, and a second side wall portion 55.

The peripheral wall portion 52 is formed in a tubular shape that covers the reaction force generating mechanism 4 from the outside in the radial direction R. In the present embodiment, the peripheral wall portion 52 is formed in a cylindrical shape centered on the reference axis X. The peripheral wall portion 52 is formed to extend from the support tubular portion 51 toward the second axial side L2.

The bottom wall portion 53 is disposed to close the opening on the second axial side L2 of the peripheral wall portion 52.

Each of the first side wall portion 54 and the second side wall portion 55 is formed to extend along the radial direction R. The first side wall portion 54 and the second side wall portion 55 are disposed separately on both sides in the axial direction L of the input member 1. In the present embodiment, the first side wall portion 54 is formed to extend outward in the radial direction R from the end portion on the first axial side L1 of the support tubular portion 51. The second side wall portion 55 is formed to extend outward in the radial direction R from the end portion on the first axial side L1 of the peripheral wall portion 52.

The linearly moving member 2 is disposed inward in the radial direction R of the support tubular portion 51. In the present embodiment, the second shaft portion 22 of the linearly moving member 2 is supported by the support tubular portion 51 from the outside in the radial direction R.

The linear motion conversion mechanism 3 includes a rotating member 31, a cam groove 32, a driven member 33, and a connecting member 34.

The rotating member 31 is a tubular member that rotates in conjunction with the rotation of the input member 1. The rotating member 31 is disposed outward in the radial direction R of the support tubular portion 51 on the reference axis X. In the present embodiment, the rotating member 31 is rotatably supported by the support tubular portion 51. The rotating member 31 is connected to the input member 1 so as to rotate integrally therewith.

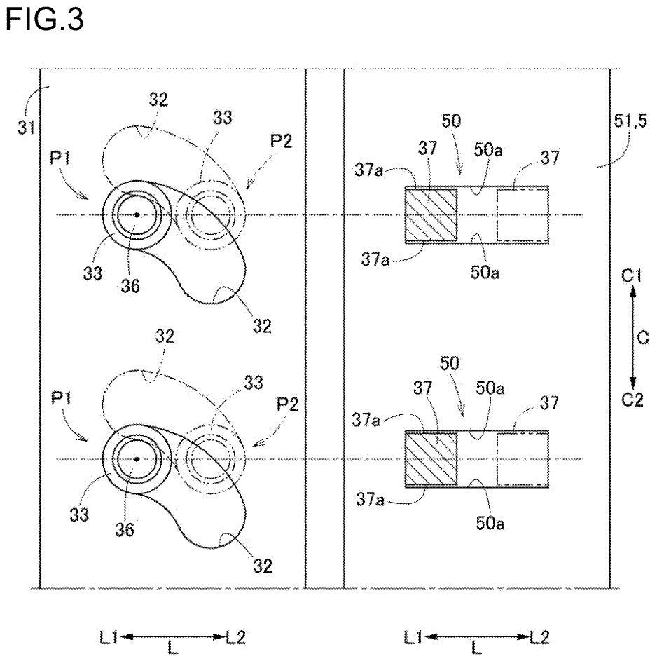

The cam groove 32 is formed in the rotating member 31. The cam groove 32 is formed to extend along a direction inclined with respect to both the axial direction L and the circumferential direction C (see FIG. 3).

The driven member 33 is a member that moves along the cam groove 32. In the present embodiment, the driven member 33 is a roller that rolls on the inner surface of the cam groove 32.

The connecting member 34 is a member that connects the driven member 33 and the linearly moving member 2 in the radial direction R. The connecting member 34 is disposed to penetrate the guide groove 50 in the radial direction R. As a result, the rotation in the circumferential direction C of the connecting member 34 is restricted by the inner surface of the guide groove 50. The connecting member 34 is fixed to one end portion in the axial direction L (here, the end portion on the first axial side L1) of the linearly moving member 2.

In the present embodiment, the connecting member 34 includes a coupling portion 35, a shaft portion 36, and a guided portion 37.

The coupling portion 35 is coupled to the linearly moving member 2. In the present embodiment, the coupling portion 35 is formed in a tubular shape that covers the connecting portion 23 of the linearly moving member 2 from the outside in the radial direction R. On the inner peripheral portion of the coupling portion 35, a plurality of splines extending in the axial direction L are formed to be distributed in the circumferential direction C. On the other hand, on the outer peripheral portion of the connecting portion 23, a plurality of splines to be engaged therewith are formed to be distributed in the circumferential direction C. Thus, in the present embodiment, the coupling portion 35 is supported movably in the axial direction L with respect to the linearly moving member 2 in a state where the rotation in the circumferential direction C is restricted.

In the present embodiment, the connecting portion 23 is formed to have a smaller diameter than the second shaft portion 22, as described above. Therefore, the coupling portion 35 supported movably in the axial direction L with respect to the connecting portion 23 is restricted from moving toward the second axial side L2 by the second shaft portion 22.

The shaft portion 36 supports the driven member 33. In the present embodiment, the shaft portion 36 rotatably supports the driven member 33 that is a roller.

The guided portion 37 is configured to be guided by the inner surface of the guide groove 50. The guided portion 37 is disposed, in the radial direction R, between the shaft portion 36 and the coupling portion 35.

In the present embodiment, the linear motion conversion mechanism 3 includes a plurality of the cam grooves 32 and a plurality of the driven members 33.

The number of the cam grooves 32 and the number of the driven members 33 are the same. The plurality of the driven members 33 are disposed to move along the plurality of the cam grooves 32, respectively. In the present embodiment, a tubular covering member 311 is connected to the rotating member 31 from the outside in the radial direction R so as to cover all the cam grooves 32. The covering member 311 is connected to the input member 1 so as to rotate integrally therewith.

In the present embodiment, the connecting member 34 includes a plurality of the shaft portions 36 and a plurality of the guided portions 37.

The number of the shaft portions 36 and the number of the guided portions 37 are the same. The number of the shaft portions 36 and the number of the driven members 33 are the same. The number of the guided portions 37 and the number of the guide grooves 50 are the same. That is, the number of the shaft portions 36, that of the guided portions 37, that of the driven members 33, and that of the guide groove 50 are the same as each other.

The plurality of the shaft portions 36 support the plurality of the driven members 33, respectively. The plurality of the guided portions 37 extend from the coupling portion 35 toward the outside in the radial direction R so as to be connected to the plurality of the shaft portions 36, respectively.

In the present embodiment, the reaction force generating mechanism 4 includes a holding member 41, an inner spring 42, and an outer spring 43.

The holding member 41 is a member for holding the inner spring 42 and the outer spring 43. In the present embodiment, the holding member 41 includes a tubular portion 411, a bottom portion 412, and a flange portion 413.

The tubular portion 411 is open on the first axial side L1 and the second axial side L2, and is formed in a cylindrical shape centered on the reference axis X. The tubular portion 411 is disposed to cover the first shaft portion 21 of the linearly moving member 2 from the outside in the radial direction R.

The bottom portion 412 is connected to the tubular portion 411 so as to close the opening on the second axial side L2 of the tubular portion 411.

The flange portion 413 is formed to protrude outward in the radial direction R from the end portion on the first axial side L1 of the tubular portion 411.

The inner spring 42 and the outer spring 43 bias the linearly moving member 2 toward the first axial side L1 via the holding member 41. In the present embodiment, each of the inner spring 42 and the outer spring 43 is a compression coil spring. The inner spring 42 is disposed, in the axial direction L, between the second shaft portion 22 of the linearly moving member 2 and the bottom portion 412 of the holding member 41 in a state where the first shaft portion 21 of the linearly moving member 2 is inserted. The outer spring 43 is disposed, in the axial direction L, between the flange portion 413 of the holding member 41 and the bottom wall portion 53 of the support member 5 in a state where the tubular portion 411 of the holding member 41 is inserted.

In the present embodiment, the operation input device 100 further includes a pair of operation amount sensors 9. The pair of operation amount sensors 9 are sensors for detecting an operation amount of the input member 1. In the present embodiment, the pair of operation amount sensors 9 are disposed outside in the radial direction R of the rotating member 31 and on both sides in the axial direction L of the input member 1. The pair of operation amount sensors 9 are configured to detect at least one of a rotation amount and twist of the rotating member 31. In addition, one operation amount sensor 9 is fixed to the first side wall portion 54, and the other operation amount sensor 9 is fixed to the second side wall portion 55.

FIG. 3 is a view in which the rotating member 31 in which the cam grooves 32 are formed and the support tubular portion 51 in which the guide grooves 50 are formed are developed on a plane along the circumferential direction C and arranged so that the positions in the circumferential direction C are aligned. In the following description, one side in the circumferential direction C is defined as a “first circumferential side C1”, and the other side in the circumferential direction C is defined as a “second circumferential side C2”.

In the present embodiment, the plurality of the cam grooves 32 are disposed in the rotating member 31 at equal intervals in the circumferential direction C, as illustrated in FIG. 3. The plurality of the guide grooves 50 are disposed in the support tubular portion 51 at equal intervals in the circumferential direction C. In the example illustrated in FIG. 3, two cam grooves 32, two driven members 33, two shaft portions 36, two guide grooves 50, and two guided portions 37 are provided.

In the present embodiment, when no rotational operation force is input to the input member 1, each of the plurality of the driven members 33 is located at a position (hereinafter, referred to as a “first position P1”) closest to the first axial side L1 in the cam groove 32. At this time, each of the plurality of the guided portions 37 in the connecting member 34 is located at a position closest to the first axial side L1 in the guide groove 50.

When a rotational operation force is input to the input member 1, each of the plurality of the driven members 33 is relatively movable to a position (hereinafter, referred to as a “second position P2”) closest to the second axial side L2 in the cam groove 32. When a rotational operation force is input to the input member 1, each of the plurality of the guided portions 37 is relatively movable to a position closest to the second axial side L2 in the guide groove 50.

In the present embodiment, the inner surface of the guide groove 50 includes a pair of guide surfaces 50a formed in a planar shape so as to face both sides in the circumferential direction C. The guided portion 37 includes a pair of guided surfaces 37a formed in a planar shape so as to face the pair of guide surfaces 50a. In the present embodiment, the distance in the circumferential direction C between the pair of guided surfaces 37a (the dimension in the circumferential direction C of the guided portion 37) is set to be about the same as the distance in the circumferential direction C between the pair of guide surfaces 50a (the dimension in the circumferential direction C of the guide groove 50), and thus relative movement in the circumferential direction C of the guided portion 37 is restricted. As a result, rotation in the circumferential direction C of the connecting member 34 with respect to the support member 5 is restricted. In the present embodiment, the surfaces of the guide groove 50 facing both sides in the axial direction L are formed in a planar shape. The surfaces of the guided portion 37 facing both sides in the axial direction L are also formed in a planar shape.

In the present embodiment, each of the plurality of the cam grooves 32 is formed such that, toward the second circumferential side C2, it gradually extends toward the second axial side L2. Therefore, in the present embodiment, the linear motion conversion mechanism 3 converts the rotational motion of the rotating member 31 toward the first circumferential side C1 into the linear motion of the linearly moving member 2 toward the second axial side L2. In addition, the linear motion conversion mechanism 3 converts the linear motion of the linearly moving member 2 toward the first axial side L1 into the rotational motion of the rotating member 31 toward the second circumferential side C2. That is, in the present embodiment, when the driver steps on the pedal 11, the rotating member 31 rotates toward the first circumferential side C1, and the linearly moving member 2 moves toward the second axial side L2 against the reaction force generated by the reaction force generating mechanism 4. On the other hand, when the driver releases the stepping on the pedal 11, the linearly moving member 2 is moved toward the first axial side L1 by the reaction force generated by the reaction force generating mechanism 4, and the rotating member 31 rotates toward the second circumferential side C2, whereby the pedal 11 returns to the initial position.

More specifically, when a rotational operation force is input to the input member 1 so that the rotating member 31 rotates toward the first circumferential side C1, the driven member 33 is pressed toward the first circumferential side C1 by the inner surface of the cam groove 32 formed in the rotating member 31 connected to the input member 1. As a result, a force directed toward the first circumferential side C1 acts on the guided portion 37 connected to the shaft portion 36 that supports the driven member 33.

However, the guided surface 37a, facing the first circumferential side C1, of the guided portion 37 comes into contact with the guide surface 50a, facing the second circumferential side C2, of the guide groove 50, and thus the rotation toward the first circumferential side C1 of the connecting member 34 with respect to the support member 5 is restricted. As a result, each of the plurality of the driven members 33 rolls from the first position P1 to the second position P2 of the cam groove 32 as the rotating member 31 rotates toward the first circumferential side C1. As a result, the linearly moving member 2 connected to the driven member 33 via the connecting member 34 moves toward the second axial side L2 against the reaction force generated by the reaction force generating mechanism 4.

On the other hand, when a rotational operation force is no longer input to the input member 1 in a state where each of the driven members 33 is located at the second position P2 of the cam groove 32, the connecting member 34 is pressed toward the first axial side L1 via the linearly moving member 2 by the reaction force generated by the reaction force generating mechanism 4. As a result, as each of the plurality of the driven members 33 rolls from the second position P2 to the first position P1 of the cam groove 32 in a state where the rotation, in the circumferential direction C, of the connecting member 34 with respect to the support member 5 is restricted by the inner surface of the guide groove 50, the rotating member 31 rotates toward the second circumferential side C2 such that the input member 1 returns to the initial position.

### 2. SECOND EMBODIMENT

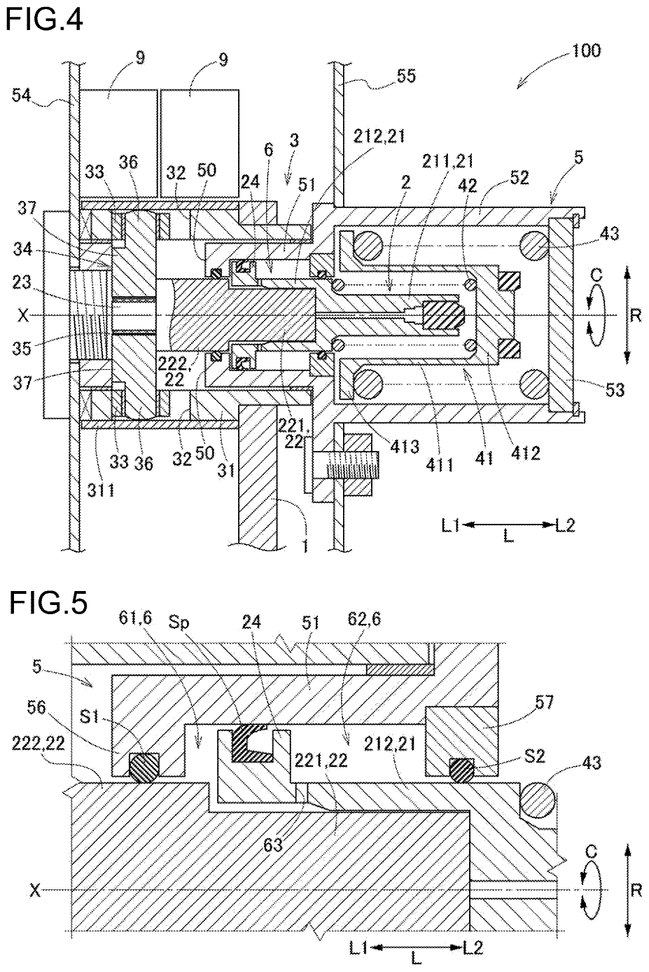

Hereinafter, an operation input device 100 according to a second embodiment will be described with reference to FIGS. 4 and 5. In the present embodiment, configurations of a linearly moving member 2, a reaction force generating mechanism 4, and a support member 5 are different from those of the first embodiment. Hereinafter, differences from the first embodiment will be mainly described. Note that points that are not particularly described are the same as those of the first embodiment.

In the present embodiment, the linearly moving member 2 further includes a piston portion 24, as illustrated in FIG. 4. The support member 5 includes a piston chamber 6 that accommodates the piston portion 24. The piston portion 24 is configured to slide on the inner peripheral surface of the piston chamber 6 along the axial direction L. In the present embodiment, the piston chamber 6 is formed, in the radial direction R, between a support tubular portion 51 of the support member 5 and a first shaft portion 21 and a second shaft portion 22 of the linearly moving member 2. The piston chamber 6 is filled with oil.

In the present embodiment, the first shaft portion 21 of the linearly moving member 2 includes a tip portion 211 and a holding portion 212.

The tip portion 211 is formed to extend from the holding portion 212 toward the second axial side L2. The tip portion 211 is formed to have a smaller diameter than the holding portion 212. The holding portion 212 is formed in a cylindrical shape centered on the reference axis X. In the present embodiment, an inner spring 42 is disposed, in the axial direction L, between the holding portion 212 and a bottom portion 412 in a state where the tip portion 211 is inserted.

In the present embodiment, the piston portion 24 is formed to protrude outward in the radial direction R from the end portion on the first axial side L1 of the holding portion 212.

In the present embodiment, the second shaft portion 22 of the linearly moving member 2 includes a small-diameter portion 221 and a large-diameter portion 222.

The small-diameter portion 221 is disposed inward in the radial direction R of the holding portion 212. The small-diameter portion 221 comes into contact with the tip portion 211 from the first axial side L1 and is restricted from moving toward the second axial side L2.

The large-diameter portion 222 is formed to have a larger diameter than the small-diameter portion 221. The large-diameter portion 222 is disposed on the first axial side L1 with respect to the small-diameter portion 221. In the present embodiment, the large-diameter portion 222 is connected to a connecting portion 23.

As illustrated in FIG. 5, the piston chamber 6 includes a first chamber 61 and a second chamber 62. The first chamber 61 is formed on the first axial side L1 with respect to the piston portion 24. The second chamber 62 is formed on the second axial side L2 with respect to the piston portion 24. In the present embodiment, the volume of the first chamber 61 is the smallest when each of the plurality of the driven members 33 is located at the first position P1 of the cam groove 32. The volume of the first chamber 61 is the largest when each of the plurality of the driven members 33 is located at the second position P2 of the cam groove 32.

In the present embodiment, the support member 5 further includes a first mounting portion 56 and a second mounting portion 57.

The first mounting portion 56 is formed to protrude inward in the radial direction R from the end portion on the first axial side L1 of the support tubular portion 51. The first mounting portion 56 is disposed to support the large-diameter portion 222 from the outside in the radial direction R. A first seal member S1 that seals a gap, in the radial direction R, between the first mounting portion 56 and the large-diameter portion 222 is attached to the inner peripheral portion of the first mounting portion 56. In the present embodiment, the first seal member S1 is an O-ring.

The second mounting portion 57 is formed to protrude inward in the radial direction R from the end portion on the second axial side L2 of the support tubular portion 51. The second mounting portion 57 is disposed to support the holding portion 212 from the outside in the radial direction R. A second seal member S2 that seals a gap, in the radial direction R, between the second mounting portion 57 and the holding portion 212 is attached to the inner peripheral portion of the second mounting portion 57. In the present embodiment, the second seal member S2 is an O-ring.

In the present embodiment, a piston seal member Sp that seals a gap, in the radial direction R, between the piston portion 24 and the support tubular portion 51 is attached to the outer peripheral portion of the piston portion 24. In the present embodiment, the piston seal member Sp is configured to allow a flow of oil from the first chamber 61 to the second chamber 62 in the gap, in the radial direction R, between the piston portion 24 and the support tubular portion 51, but to restrict a flow of oil from the second chamber 62 to the first chamber 61.

In the present embodiment, the first chamber 61 is formed of a space surrounded by the small-diameter portion 221, the large-diameter portion 222, the piston portion 24, the support tubular portion 51, and the first mounting portion 56. The second chamber 62 is formed of a space surrounded by the holding portion 212, the piston portion 24, the support tubular portion 51, and the second mounting portion 57.

In the present embodiment, the first chamber 61 and the second chamber 62 are configured to communicate with each other through a communication passage 63. In the present embodiment, the communication passage 63 is formed to penetrate the holding portion 212 in the radial direction R. The communication passage 63 is formed to communicate a space in the first chamber 61, the space being formed, in the radial direction R, between the piston portion 24 and the small-diameter portion 221, and the second chamber 62.

In the present embodiment, when the piston portion 24 moves toward the second axial side L2 from a state where the volume of the first chamber 61 is the smallest (state where the piston portion 24 is located at a position closest to the first axial side L1), oil flows from the second chamber 62 to the first chamber 61 through the communication passage 63 as the piston portion 24 moves toward the second axial side L2. At this time, the flow of oil from the second chamber 62 to the first chamber 61 in the gap, in the radial direction R, between the piston portion 24 and the support tubular portion 51 is restricted by the piston seal member Sp. Therefore, relatively large fluid resistance of oil acts on the piston portion 24 moving toward the second axial side L2.

On the other hand, when the piston portion 24 moves toward the first axial side L1 from a state where the volume of the first chamber 61 is the largest (state where the piston portion 24 is located at a position closest to the second axial side L2), oil flows from the first chamber 61 to the second chamber 62 through the communication passage 63 as the piston portion 24 moves toward the first axial side L1. At this time, oil also flows from the first chamber 61 to the second chamber 62 in the gap, in the radial direction R, between the piston portion 24 and the support tubular portion 51. Therefore, relatively small fluid resistance of oil acts on the piston portion 24 moving toward the first axial side L1.

In the present embodiment, the reaction force generating mechanism 4 includes the piston chamber 6 and the communication passage 63 that communicates the first chamber 61 and the second chamber 62, as described above. Note that the volume of the piston chamber 6, the flow passage cross-sectional area of the communication passage 63, and the like are set according to the reaction force generated by the reaction force generating mechanism 4.

### 3. OTHER EMBODIMENTS

(1) In the above embodiments, the configuration in which the input member 1 is connected to the pedal 11 operated by a driver of the vehicle has been described as an example. However, without being limited to such a configuration, a configuration may be adopted, in which, for example, the input member 1 is connected to a steering wheel or an operation lever.
(2) In the above embodiments, the configuration in which the reaction force generating mechanism 4 includes the inner spring 42 and the outer spring 43, which are compression coil springs, has been described as an example. However, without being limited to such a configuration, a configuration may be adopted, in which, for example, the reaction force generating mechanism 4 includes a friction member disposed between the linearly moving member 2 and the support member 5.
(3) In the above embodiments, the configuration in which the reaction force generating mechanism 4 is accommodated in the support member 5 has been described as an example. However, without being limited to such a configuration, a configuration may be adopted, in which, for example, the reaction force generating mechanism 4 is supported by another member without being accommodated in the support member 5.
(4) In the above embodiments, the configuration in which the rotating member 31 is connected to the input member 1 so as to rotate integrally therewith has been described as an example. However, without being limited to such a configuration, a configuration may be adopted, in which the input member 1 is disposed on a shaft different from the rotating member 31 and is connected to the rotating member 31 via a gear mechanism or the like.
(5) In the above embodiments, the configuration in which two cam grooves 32, two driven members 33, two shaft portions 36, two guide grooves 50, and two guided portions 37 are provided has been described as an example. However, without being limited to such a configuration, a configuration may be adopted, in which one or three or more of each of the cam groove 32, the driven member 33, the shaft portion 36, the guide groove 50, and the guided portion 37 are provided.
(6) In the above embodiments, the configuration in which the linearly moving member 2 and the coupling portion 35 are coupled by spline engagement has been described as an example. However, without being limited to such a configuration, a configuration may be adopted, in which, for example, the linearly moving member 2 and the coupling portion 35 are threadedly engaged with each other.
(7) In the second embodiment, the configuration in which the piston chamber 6 is filled with oil has been described as an example. However, without being limited to such a configuration, a configuration may be adopted, in which the piston chamber 6 is filled with a fluid other than oil.
(8) In the second embodiment, the configuration in which the communication passage 63 is formed in the holding portion 212 of the first shaft portion 21 in the linearly moving member 2 has been described as an example. However, without being limited to such a configuration, a configuration may be adopted, in which, for example, the communication passage 63 is formed in the support member 5.
(9) In the second embodiment, the configuration has been described as an example, in which the piston seal member Sp that allows a flow of oil from the first chamber 61 to the second chamber 62 but restricts a flow of oil from the second chamber 62 to the first chamber 61 is disposed, in the radial direction R, between the piston portion 24 and the support tubular portion 51. However, without being limited to such a configuration, a configuration may be adopted, in which, for example, instead of the piston seal member Sp, a seal member similar to the first seal member S1 and the second seal member S2 is provided, in the radial direction R, between the piston portion 24 and the support tubular portion 51, and a check valve that allows a flow of oil from the first chamber 61 to the second chamber 62 but restricts a flow of oil from the second chamber 62 to the first chamber 61 is provided in an oil passage that communicates the first chamber 61 and the second chamber 62.
(10) Note that the configuration disclosed in each of the above-described embodiments can be applied in combination with the configurations disclosed in other embodiments as long as there is no contradiction. Regarding other configurations, the embodiments disclosed in the present specification are merely examples in all respects. Therefore, various modifications can be appropriately made without departing from the gist of the present disclosure.

### 4. SUMMARY OF THE PRESENT EMBODIMENTS

Hereinafter, an outline of the operation input device (100) described above will be described.

An operation input device (100) includes:
an input member (1) to which a rotational operation force is input;
a linearly moving member (2) disposed on a reference axis (X);
a linear motion conversion mechanism (3) that mutually converts rotational motion of the input member (1) and linear motion of the linearly moving member (2) along the reference axis (X);
a reaction force generating mechanism (4) that generates a reaction force against the rotational operation force input to the input member (1) and causes the reaction force to act on the linearly moving member (2); and
a support member (5) that supports the input member (1), the linearly moving member (2), and the linear motion conversion mechanism (3), in which
defining a direction along the reference axis (X) as an axial direction (L), a direction orthogonal to the reference axis (X) as a radial direction (R), and a direction around the reference axis (X) as a circumferential direction (C),
the support member (5) includes a support tubular portion (51) formed in a tubular shape and disposed on the reference axis (X),
the linearly moving member (2) is disposed inward in the radial direction (R) of the support tubular portion (51),
the linear motion conversion mechanism (3) includes:
a tubular rotating member (31) that is disposed outward in the radial direction (R) of the support tubular portion (51) on the reference axis (X) and rotates in conjunction with rotation of the input member (1);
a cam groove (32) formed in the rotating member (31) so as to extend along a direction inclined with respect to both the axial direction (L) and the circumferential direction (C);
a driven member (33) that moves along the cam groove (32); and
a connecting member (34) that connects the driven member (33) and the linearly moving member (2) in the radial direction (R),
a long hole-shaped guide groove (50) that penetrates the support tubular portion (51) in the radial direction (R) and extends along the axial direction (L) is formed in the support tubular portion (51), and
the connecting member (34) is fixed to one end portion in the axial direction (L) of the linearly moving member (2) in a state of penetrating the guide groove (50) in the radial direction (R) so that the rotation in the circumferential direction (C) is restricted by an inner surface of the guide groove (50).

According to this configuration, the connecting member (34) is fixed to one end portion in the axial direction (L) of the linearly moving member (2), and thus, for example, it is not necessary to provide a through hole for inserting the connecting member (34) in the linearly moving member (2). As a result, it is easy to secure the rigidity of the linearly moving member (2), so that the dimensions in the radial direction (R) and the axial direction (L) of the linearly moving member (2) can be easily reduced.

According to the present configuration, the connecting member (34) can be assembled, in the axial direction (L), to the linearly moving member (2) at the time of manufacturing the operation input device (100). As a result, workability at the time of manufacturing the operation input device (100) can be improved more easily than the case where the connecting member (34) is inserted into the through hole in the linearly moving member (2), as described above.

According to the present configurations, the connecting member (34) that connects the driven member (33) and the linearly moving member (2) in the radial direction (R) is disposed to penetrate, in the radial direction (R), the guide groove (50) of the support tubular portion (51) disposed, in the radial direction (R), between the driven member (33) and the linearly moving member (2), and is supported in the circumferential direction (C) by the inner surface of the guide groove (50). As a result, deflection of the connecting member (34) in the circumferential direction (C) can be reduced, and the support rigidity of the driven member (33) can be easily secured.

Here, it is preferable that
the connecting member (34) includes:
a coupling portion (35) coupled to the linearly moving member (2);
a shaft portion (36) that supports the driven member (33); and
a guided portion (37) that is disposed, in the radial direction (R), between the shaft portion (36) and the coupling portion (35) and is guided by the inner surface of the guide groove (50), in which
the inner surface of the guide groove (50) includes a pair of guide surfaces (50a) formed in a planar shape so as to face both sides in the circumferential direction (C), and
the guided portion (37) includes a pair of guided surfaces (37a) formed in a planar shape so as to face the pair of guide surfaces (50a).

According to this configuration, the pair of guided surfaces (37a) in the guided portion (37) and the pair of guide surfaces (50a) in the guide groove (50) can be brought into planar contact with each other. As a result, the load in the circumferential direction (C) acting on the connecting member (34) can be supported over a wide surface. Therefore, deflection of the connecting member (34) in the circumferential direction (C) can be further reduced.

In the above configuration, it is preferable that
the linear motion conversion mechanism (3) includes a plurality of the cam grooves (32) and a plurality of the driven members (33), in which
the plurality of the cam grooves (32) are disposed in the rotating member (31) at equal intervals in the circumferential direction (C),
the plurality of the driven members (33) are disposed to move along the plurality of the cam grooves (32), respectively,
the connecting member (34) includes a plurality of the shaft portions (36) and a plurality of the guided portions (37),
the plurality of the shaft portions (36) support the plurality of the driven members (33), respectively, and
the plurality of the guided portions (37) extend outward in the radial direction (R) from the coupling portion (35) so as to be connected to the plurality of the shaft portions (36), respectively.

According to this configuration, biased loads acting on the linearly moving member (2) and the connecting member (34) can be reduced. Therefore, it is easy to reduce the size of the linearly moving member (2) and the connecting member (34) while securing the rigidities thereof.

It is also preferable that
the linearly moving member (2) includes a piston portion (24),
the support member (5) includes a piston chamber (6) that accommodates the piston portion (24),
the piston portion (24) is configured to slide on an inner peripheral surface of the piston chamber (6) along the axial direction (L),
the piston chamber (6) includes a first chamber (61) formed on one side in the axial direction (L) of the piston portion (24) and a second chamber (62) formed on the other side in the axial direction (L) of the piston portion (24), and
the reaction force generating mechanism (4) includes the piston chamber (6) and a communication passage (63) that communicates the first chamber (61) and the second chamber (62).

According to this configuration, as the piston portion (24) moves in the axial direction (L), a reaction force against the rotational operation force input to the input member (1) can be generated by the resistance of the fluid flowing between the first chamber (61) and the second chamber (62) through the communication passage (63). Therefore, the magnitude of the reaction force can be changed according to a speed at which the input member (1) is operated, and it is easy to improve an operation feel in response to an operation of the input member (1).

The technology according to the present disclosure can be used in an operation input device including: an input member to which a rotational operation force is input; a linearly moving member disposed on a reference axis; a linear motion conversion mechanism that mutually converts rotational motion of the input member and linear motion of the linearly moving member along the reference axis; a reaction force generating mechanism that generates a reaction force against the rotational operation force input to the input member and causes the reaction force to act on the linearly moving member; and a support member that supports the input member, the linearly moving member, and the linear motion conversion mechanism.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An operation input device comprising:
an input member to which a rotational operation force is input;
a linearly moving member disposed on a reference axis;
a linear motion conversion mechanism that mutually converts rotational motion of the input member and linear motion of the linearly moving member along the reference axis;
a reaction force generating mechanism that generates a reaction force against the rotational operation force input to the input member and causes the reaction force to act on the linearly moving member; and
a support member that supports the input member, the linearly moving member, and the linear motion conversion mechanism, wherein
defining a direction along the reference axis as an axial direction, a direction orthogonal to the reference axis as a radial direction, and a direction around the reference axis as a circumferential direction,
the support member includes a support tubular portion formed in a tubular shape and disposed on the reference axis,
the linearly moving member is disposed inward in the radial direction of the support tubular portion,
the linear motion conversion mechanism includes:
a tubular rotating member that is disposed outward in the radial direction of the support tubular portion on the reference axis and rotates in conjunction with rotation of the input member;
a cam groove formed in the rotating member so as to extend along a direction inclined with respect to both the axial direction and the circumferential direction;
a driven member that moves along the cam groove; and
a connecting member that connects the driven member and the linearly moving member in the radial direction,
a long hole-shaped guide groove that penetrates the support tubular portion in the radial direction and extends along the axial direction is formed in the support tubular portion, and
the connecting member is fixed to one end portion in the axial direction of the linearly moving member in a state of penetrating the guide groove in the radial direction so that the rotation in the circumferential direction is restricted by an inner surface of the guide groove.

2. The operation input device according to claim 1, wherein
the connecting member includes:
a coupling portion coupled to the linearly moving member;
a shaft portion that supports the driven member; and
a guided portion disposed, in the radial direction, between the shaft portion and the coupling portion and guided by the inner surface of the guide groove,
the inner surface of the guide groove includes a pair of guide surfaces formed in a planar shape so as to face both sides in the circumferential direction, and
the guided portion includes a pair of guided surfaces formed in a planar shape so as to face the pair of guide surfaces.

3. The operation input device according to claim 2, wherein
the linear motion conversion mechanism includes a plurality of the cam grooves and a plurality of the driven members,
the plurality of the cam grooves are disposed in the rotating member at equal intervals in the circumferential direction,
the plurality of the driven members are disposed to move along the plurality of the cam grooves, respectively,
the connecting member includes a plurality of the shaft portions and a plurality of the guided portions,
the plurality of the shaft portions support the plurality of the driven members, respectively, and
the plurality of the guided portions extends outward in the radial direction from the coupling portion so as to be connected to the plurality of the shaft portions, respectively.

4. The operation input device according to claim 1, wherein
the linearly moving member includes a piston portion,
the support member includes a piston chamber that accommodates the piston portion,
the piston portion is configured to slide on an inner peripheral surface of the piston chamber along the axial direction,
the piston chamber includes a first chamber formed on one side in the axial direction of the piston portion and a second chamber formed on the other side in the axial direction of the piston portion, and
the reaction force generating mechanism includes the piston chamber and a communication passage that communicates the first chamber and the second chamber.

5. The operation input device according to claim 2, wherein
the linearly moving member includes a piston portion,
the support member includes a piston chamber that accommodates the piston portion,
the piston portion is configured to slide on an inner peripheral surface of the piston chamber along the axial direction,
the piston chamber includes a first chamber formed on one side in the axial direction of the piston portion and a second chamber formed on the other side in the axial direction of the piston portion, and
the reaction force generating mechanism includes the piston chamber and a communication passage that communicates the first chamber and the second chamber.

6. The operation input device according to claim 3, wherein
the linearly moving member includes a piston portion,
the support member includes a piston chamber that accommodates the piston portion,
the piston portion is configured to slide on an inner peripheral surface of the piston chamber along the axial direction,
the piston chamber includes a first chamber formed on one side in the axial direction of the piston portion and a second chamber formed on the other side in the axial direction of the piston portion, and
the reaction force generating mechanism includes the piston chamber and a communication passage that communicates the first chamber and the second chamber.
